(19) United States
(12) Patent Application Publication
(10) Pub. No.: US 2017/0073192 A1
(43) Pub. Date: Mar. 16, 2017

(54) ELECTRIC ELEVATOR PAD EXTRACTION AND RETRACTION SYSTEM

(71) Applicants: Jaciel Oliveira, Boynton Beach, FL (US); Rodrigo De Jesus Oliveira, Lake Worth, FL (US); Danielle Oliveira, Delray Beach, FL (US)

(72) Inventors: Jaciel Oliveira, Boynton Beach, FL (US); Rodrigo De Jesus Oliveira, Lake Worth, FL (US); Danielle Oliveira, Delray Beach, FL (US)

(21) Appl. No.: 15/262,127

(22) Filed: Sep. 12, 2016

Related U.S. Application Data
(60) Provisional application No. 62/219,178, filed on Sep. 16, 2015.

(51) Int. Cl. B66B 11/02

(52) U.S. Cl. CPC B66B 11/0226

(57) ABSTRACT

The present invention relates to an extendable and retractable elevator pad system comprising at least one motor, wherein the motor is attached to an elevator; a plurality of mounts, wherein at least one of the mounts is connected to the motor; a first plurality of shafts, wherein the shafts have a predetermined section with grooves and at least one of the first plurality of shafts connects to the mount which is connected to the motor; a plurality of gears, wherein the gears are sized to mate with the grooved section of the first plurality of shafts; a second plurality of shafts, wherein the second plurality of shafts are mated with the plurality of gears; and a series of pads, wherein the pads are connected to at least the second plurality of shafts.

### BACKGROUND

The invention generally relates to an apparatus and method for extracting and retracting pads, and more particularly to extracting and retracting pads in an elevator.

Freight elevator also known as goods lift are a kind of elevator used to carry goods. These usually have rugged interior finishes to prevent any damage to the elevator while loading and unloading of the goods. However, office and apartment buildings lack a freight elevator and in these buildings a normal passenger elevator is used to carry both passengers and goods.

Interiors of passenger elevators are prone to damage as they are made to carry passengers and not large and bulky goods. These are usually made of wood, fabric or steel that could be easily scratched by large and bulky goods, causing damage to the interiors. Some buildings may have elevators with expensive interiors to increase the ornamental valve.

Thus to protect the interiors of an elevator from damage while carrying large and bulky goods, It's a common practice to suspend pads over the walls of the lift. These pads are specialized protective pads and are installed manually each time a person used the elevator to carry the large or bulky goods. These pads are generally held by a row of hooks which are screwed into the elevator wall.

Therefore, a manual process of installation of the pads to cover the elevator walls is quite laborious and time consuming. Particularly during the day time when elevators are used the most. This creates an inconvenience to the person moving the large or bulky goods and other people trying to use the elevator. Moreover, these pads are loosely supported to the wall of elevator which may come unhooked from the wall, adding additional labor due to the reinstalling of the pads. Furthermore, these pads need a safe location to be stored so they are protected when not in use and are protected from being stolen.

Therefore, an apparatus which can be installed in the elevator that can extend and retract the pads is desired.

### SUMMARY OF THE INVENTION

Aspect of an embodiment of the present invention include an extendable and retractable elevator pad system comprising at least one motor, wherein the motor is attached to an elevator; a plurality of mounts, wherein at least one of the mounts is connected to the motor; a first plurality of shafts, wherein the shafts have a predetermined section with grooves and at least one of the first plurality of shafts connects to the mount which is connected to the motor; a plurality of gears, wherein the gears are sized to mate with the grooved section of the first plurality of shafts; a second plurality of shafts, wherein the second plurality of shafts are mated with the plurality of gears; and a series of pads, wherein the pads are connected to at least the second plurality of shafts.

### BRIEF DESCRIPTION OF THE SEVERAL VIEWS OF THE DRAWINGS

FIG. 1 illustrates a perspective view of the pad extraction and retraction assembly, in accordance with one embodiment of the invention.

### DETAILED DESCRIPTION

As will be appreciated by one skilled in the art, aspects of the present invention may be embodied as a system, apparatus or method. Accordingly, aspects of the present invention may receive the form of an entirely hardware embodiment, an entirely software embodiment (including firmware, resident software, micro-code, etc.) or an embodiment combining software and hardware aspects that may generally be referred to herein as a “circuit,” “module” or “system.” Furthermore, aspects of the present invention may receive the form of a computer program product embodied in one or more computer readable medium(s) having computer readable program code/instructions embodied thereon.

Embodiments of the present invention recognize that current elevators designed for passengers do not account for padding to protect the elevator in the event the passengers want to move a large or bulky item. Generally, the passengers have to be careful, but this does not always work and the elevator can get damaged. Some elevators have pads which have to manually installed but this is both difficult and time consuming.

Embodiments of the present invention help reduce the need to install the pads in the elevator. Embodiments of the present invention add a motorized system to extract and retract the pads with ease.

Embodiments of the present invention disclose a method and apparatus to provide for a motorized set of pads that can be extracted and retracted with ease so when a passenger is moving a large or bulky item they can easily extract the pads, and retract them when they have moved the item to return the elevator to a clean and ascetically pleasing look.

The present invention will now be described in detail with reference to the FIGURES.

The present invention, has as its principal object to provide an apparatus and method for extending and retracting of pads in an elevator. The present invention in one embodiment may be installed in the elevator when built. In additional embodiments, the present invention is retrofit into the elevator. The present invention can be used to cover either any predetermined number of the walls of the elevator by either adding or removing pads.

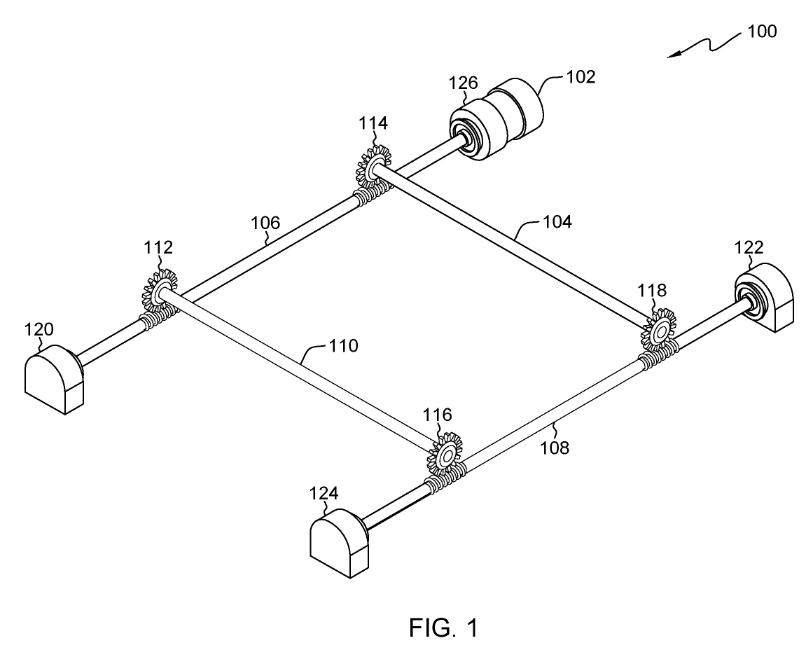

Referring to FIG. 1, the illustration of an extraction and retraction assembly in a perspective view. The extraction and retraction assembly 100 is comprised of motor 102, shafts 104, 106, 108, 110, gears 112, 114, 116, 118, mounts 120, 122, 124, 126, a switch, a power supply, and at least one pad (not shown).

The motor 102 is designed to attached to one of mounts 120, 122, 124, or 126 and provide enough power to extract and retract the pad and/or pads. The motor 102 controls the retraction and extraction of the pads by rotating either shaft 106, shaft 108, or if two motors are used both shafts 106 and 108. For example, if the motor 102 is attached to mount 120 then it will rotate shaft 106 and if the motor is attached to mount 124 then it will rotate shaft 108. The type of motor 102 which is installed determines the speed, and rotational strength. These characteristics of the motor 102 determine the type of pads which can be used. The motor should have adequate power and speed to extract and retract the pads which are installed. In one embodiment, motor 102 is reversible to allow for the extraction and retraction of the pad(s). In one embodiment, the motor 102 has a capacity of 0.5 V. In additional embodiments, the motor 102 has a capacity that is great than or less than 0.5V. In some embodiments, more than one motor is used and is connected to either the same or different mounts.

Shafts 106 and 108 are sized to connect mount 120 to mount 126 and mount 122 to mount 124 respectively. Shafts 106 and 108 have a predetermined section of the shaft which is grooved with teeth to interact with gears 112 and 114 respectively. The depth of the grooves and the length of the grooves along the shafts is predetermined based on the intended uses of the assembly. This can be modified based on, but not limited to, the size of the elevator, the size and weight of the pads, and the like. In additional embodiments, the grooved section of shafts 106 and 108 may have a varying depth or length. In additional embodiments, the grooved section of shafts 106 and 108 may be a heliacal extrusion that extends a predetermined distance of the shaft.

Shafts 104 and 110 are sized to fit between shafts 106 and 108. A predetermined distance from the ends of shafts 104 and 110 a gear is secured to each end of the shaft. The gears interface with the grooved section of shafts 106 and 108 to allow the entire assembly to rotate with the use of one motor. In one embodiment, both shafts 104 and 110 have a gear of equal size on each end. In additional embodiments, shafts 104 and 110 may have fewer than two gears and the gears may be of varying sizes.

Shafts 104, 106, 108, and 110 are designed to be strong enough to handle the rotational torsion and the weight of the pads. In one embodiment, the shafts are made from aluminum. In additional embodiments, the shafts are made from steel, brass, bronze, copper, stainless steel alloys, plastics, composites, and the like. Shafts 104, 106, 108, and 110 are designed with connection means for the pad to attached to the shafts. In one embodiment, the connection means can be hooks, clasps, latches, snaps, grommets and studs, or the like. In additional embodiments, the connection means can be an opening in the shaft with the pad connects to through a hook or hook like feature of the pad.

Gears 112, 114, 116, and 118 are designed to attached to shafts 104 and 110, and designed to mate with the grooved section of shafts 106 and 108. Gears 112, 114, 116, and 118 have a predetermined number of teeth or notches to coincide with the grooved sections of shafts 106 and 108. The teeth or notches on gears 112, 114, 116, and 118 also have a predetermined depth and thickness to coincide with the grooved section of shafts 106 and 108. In some embodiments, gears 112, 114, 116, and 118 are made out of steel, brass, copper, steel alloy, aluminum, plastic, polymers, composites or other material that can handle the load of the pads, and the forces exerted on the gears. In one embodiment, gears 112, 114, 116, and 118 are attached to the shafts with the use of a pin, set screw, keyways, splines, shaft collars, welding, adhesive, pressure fit, or the like. In one embodiment, gears 112, 114, 116, and 118 are of equal size and teeth depth. In additional embodiments, gears 112, 114, 116, and 118 are of varying sizes and teeth depth.

In some embodiments, the grooved section of shaft 106 and 108 and the gears 112, 114, 116, and 118 for a spur gear system, a straight bevel gear system, a spiral bevel gear system, a worm gear set, a herringbone gear system, a helical gear system, or the like.

Mounts 120, 122, 124, and 126 are designed to receive shafts 106 and 108, and to permit shafts 106 and 108 to rotate. Mounts 120, 122, 124, and 126 are designed to handle the weight of the assembly, and permit the shafts to rotate. In the shown embodiment, motor 102 is connected to mount 126 which controls the movement of the assembly. In additional embodiments, motor 102 is connected to mount 120, 122, 124, or 126. In additional embodiments, mounts 120, 122, 124, and/or 126 are connected to a motor. In one embodiment, mounts 120, 122, 124, and 126 permit shafts 106 and 108 to rotate freely without the use of the motor. In additional embodiments, mounts 120, 122, 124, and 126 do not rotate freely without the assistance of the motor. In some embodiments, mounts 120, 122, 124, and 126 are made out of steel, brass, copper, steel alloy, aluminum, plastic, polymers, composites or other material that can handle the load of the pads, and the forces exerted on the gears. In one embodiment, mounts 120, 122, 124, and 126 are attached to the shafts with the use of a pin, set screw, keyways, splines, shaft collars, welding, adhesive, pressure fit, or the like.

The power supply is designed to provide enough power to the motor 102 to adequately operate the assembly. The power supply supplies enough power to allow the motor to extend and retract the pads from their starting position to their stopping position. In one embodiment, the power supply is an additional element of the elevator. In another embodiment, the assembly uses the power source of the elevator to supply the necessary power to the motor 102.

The switch, is used to activate the motor 102 which in turn extracts or retracts the pads. The switch can be located in the elevator, on site in the building (at a security desk or main office), or can be controlled wirelessly with a controller.

The present invention can be modified depending on the type of elevator the invention is installed in. For instance, if the elevator had two doors or one door, the width and depth of the elevator, or the walls which are desired to be protected. This can be as simple as extending or contracting shafts 104, 106, 108, or 110. Or can require additional shafts, gears, and mounts to allow the system to cover all the desired surfaces.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

It is to be understood that the invention is not limited in its application to the details of construction and the arrangements of the components set forth in the following description. The invention is capable of other embodiments and of being practiced and carried out in various ways. Also it is to be understood that the phraseology and terminology employed herein are for the purpose of description and should not be regarded as limiting.

1. A extendable and retractable elevator pad system comprising:
at least one motor, wherein the motor is attached to an elevator;
a plurality of mounts, wherein at least one of the mounts is connected to the motor;
a first plurality of shafts, wherein the shafts have a predetermined section with grooves and at least one of the first plurality of shafts connects to the mount which is connected to the motor;
a plurality of gears, wherein the gears are sized to mate with the grooved section of the first plurality of shafts;
a second plurality of shafts, wherein the second plurality of shafts are mated with the plurality of gears; and
a series of pads, wherein the pads are connected to at least the second plurality of shafts.

2. The second plurality of shafts of claim 1, wherein the second plurality of shafts have a connection means to attached to the series of pads.

3. The first plurality of shafts of claim 1, wherein the first plurality of shafts has a connection means to attached to the series of pads.

4. The extendable and retractable elevator pad system of claim 1 further comprising a power source, wherein the power source powers the motor.

5. The extendable and retractable elevator pad system of claim 1 further comprising a switch to control the motor.

6. The switch of claim 5, wherein the switch is directly connected to the motor.

7. The switch of claim 5, wherein the switch is wirelessly connected to the motor.

8. The switch of claim 5, wherein the switch has the ability to extract, stop, and retract the pads.

9. The first plurality of shafts of claim 1, wherein the entirety of the first plurality of shafts are grooved.

10. The plurality of gears of claim 1, wherein the plurality of gears are of varying sizes.

11. The motor of claim 1, wherein the motor has a capacity of 0.5 volts.

12. The first plurality of shafts of claim 1, wherein the predetermined section with grooves is a helical groove.

13. The extendable and retractable elevator pad system of claim 1, wherein the first plurality of shafts and the plurality of gears form a worm gear set.

14. A method of extracting and retracting pads in an elevator comprising:
activating a motor to rotate a first shaft with a grooved section;
rotating a gear that is mated to the grooved section of the first shaft;
rotating a second shaft which is connected to the gear;
adjusting the height of a pad attached to the second shaft.

15. The method of claim 10 further comprising activating the motor to rotate the first shaft with a remote starter.

16. The method of claim 10 further comprising incorporating an activation panel in the elevator.

17. The method of claim 10, further comprising mounting the motor, the first shaft, and the second shaft in the elevator.

18. A extendable and retractable elevator system comprising:
a motor connected to a first mount, wherein the mount is secured to a first shaft with a first set of grooved section, which is secured to a second mount, a first set of gears are fitted to mate with the grooved section of the first shaft, and the first set of gears are connected to a set of shafts on a first end of the set of shafts and on a second end of the set of shafts is a second set of gears, the second set of gears are sized to mate with a second grooved section of a second shaft with the second grooved section, and the second shaft is connected to a third mount at the first end of the second shaft and a forth mount at the second end of the second shaft.

19. The extendable and retractable elevator system of claim 18, further comprising a plurality of pads connected to the first shaft and the second shaft.

20. The extendable and retractable elevator system of claim 18, further comprising a second motor connected to one of the mounts which the first motor is not connected to.
